(19) United States
(12) Patent Application Publication
(10) Pub. No.: US 2007/0199906 A1
(43) Pub. Date: Aug. 30, 2007

(54) Treatment Assembly for Solids Contained in Waste Water and Process Liquids

(76) Inventors: Norris Wayne McCauley, Houston, TX (US); Gerald Seidl, Houston, TX (US)

Correspondence Address: James E. Bradley;BRACEWELL & GIULIANI LLP, P.O. Box 61389, Houston, TX, 77208-1389, US

(21) Appl. No.: 11/680,211

(22) Filed: Feb. 28, 2007

Related U.S. Application Data
(60) Provisional application No. 60/777,363, filed on Feb. 28, 2006.

(51) Int. Cl. B01D 29/78; B01D 29/62

(52) U.S. Cl. 210/772; 210/407

(57) ABSTRACT

A treatment assembly removes and cleans solids located in a stream of liquid. A screen filter has a lower portion located in a channel to remove the solids from the liquid flowing through the channel. Once removed, the screen filter deposits the solids into an agitator assembly. Wash water is fed continuously into the agitator assembly, and the agitator within creates turbulence to clean the solids. The wash water and solids are continuously removed from the agitator assembly for further processing.

### CROSS-REFERENCE TO RELATED APPLICATION

This is a non-provisional patent application which claims the priority of provisional patent application U.S. Ser. No. 60/777,363, filed Feb. 28, 2006, entitled “Waste Water Treatment Assembly,” which is incorporated herein by reference in its entirety.

### BACKGROUND OF THE INVENTION

1. Field of the Invention

This invention relates generally to a treatment assembly for solids screened from waste water and process liquids, and more particularly to an agitator assembly that creates turbulent flow a liquid stream containing the screened materials.

2. Background of the Invention

Many applications exist where solids need to be removed from a liquid, For example, wood pulp is removed from a liquid in paper mills. Rubbish and sand typically must be removed from municipal waste water.

In prior art waste water and process liquid treatment systems, a screening assembly lifts solids or screenings out of a flow channel and then delivers the screenings for further processing. The screening assembly might be a rake screen, a perforated movable screen, a perforated band screen, a spiral screen, a drum screen or other mechanisms. The screening assembly might deposit the screenings into a fluid flow in a conduit or channel or on a belt to deliver the screenings to further processing equipment. The further processing of the screenings might include washing, compacting, drying and other treatments. Particularly with municipal waste water, further treatment might include washing the screenings to remove organic components from the screenings, then incinerating or dumping the cleansed screenings in a landfill. The slurry of water and separated organic matter is further treated before disposal.

U.S. Pat. No. 5,641,360 discloses various embodiments of assembly for washing screenings. Each embodiment employs an agitator for creating a vortex around the screenings for cleaning. The various embodiments employ batch processes for removing the solids.

### SUMMARY OF THE INVENTION

In this invention, the first step comprises separating the solids from the liquid with a screen filter. The screen filter deposits the solids into an agitator assembly. Wash water flows through the agitator assembly, and the agitator assembly creates turbulence to clean the solids. The solids are removed continuously from the agitator assembly for further processing.

Preferably, the entire operation is continuous and performed simultaneously. In one embodiment, the solids are removed by entraining them in the wash water and discharging the wash water continuously out of the agitator assembly. In this embodiment, the agitator assembly has an outlet that is positioned at an elevation so as to maintain a desired level of wash water in the agitator assembly. The wash water and entrained solids flow out the outlet.

The solids may comprise rubbish found in a municipal waste water treatment facility. Alternatively, the solids may comprise products that are further processed into a final product in a process industry, such as a paper mill.

### BRIEF DESCRIPTION OF THE DRAWINGS

FIG. 1 is schematic view of a liquid treatment assembly with a partial section view of an agitator assembly, each being constructed in accordance with the present invention.

FIG. 2 is a schematic sectional view of the agitator assembly shown in FIG. 1.

FIG. 3 is a schematic sectional view of the agitator assembly taken along line 3-3 of FIG. 2.

### DETAILED DESCRIPTION OF THE PREFERRED EMBODIMENT

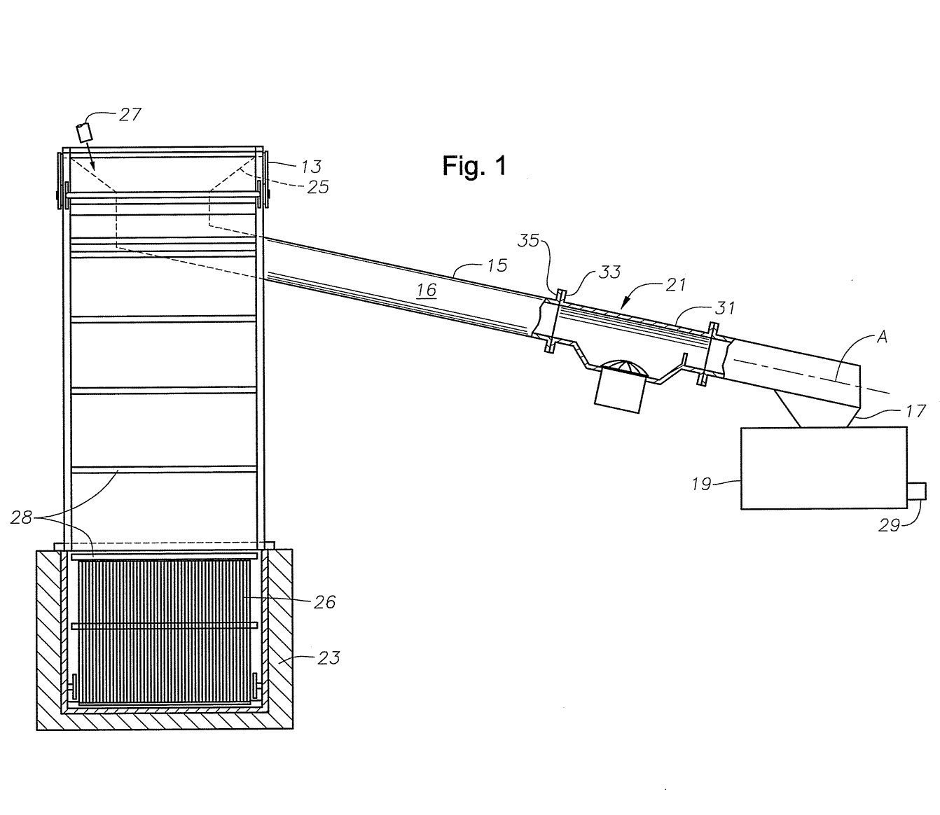

Referring to FIG. 1, a liquid treatment assembly 11 includes a screen 13 and optionally a conveyor 15 extending therefrom. Conveyor 15 is preferably a tubular member having an interior flow path 16 extending from screen 13 to a chute 17. Chute 17 defines a pathway from conveyor 15 to processing equipment 19. In the preferred embodiment, an agitator assembly 21 is positioned in conveyor 15 adjacent chute 17. Alternatively, agitator assembly 21 could be mounted directly to screen 13 and conveyor 15 eliminated.

Screen 13 typically comprises a filter unit having a lower portion in a flow channel 23 through which a liquid is flowing, such as municipal waste water or sewage for treatment. The liquid flowing through channel 23 typically includes solids, sand, rubbish and the like. Screen 13 advantageously separates solid matter from the liquid flowing through flow channel 23. Screen 13 lifts the solids or screenings from channel 23 and deposits them into a hopper or chute 25.

Screen 13 may be a variety of types for trapping debris and lifting the debris from channel 23, such as a perforated movable screen, a perforated band screen, a spiral screen, a drum screen or a rake screen as shown. In the type shown, screen 13 has parallel bars 26 through which the liquid flows. Ralkes 28 move vertically along screen 13 to remove debris trapped by parallel bars 26. Rakes 28 deposit the solids on conveyer 15 via chute 25. Alternatively, a movable perforated screen having shelves formed therein to lift the trapped solids could be used. In this embodiment, conveyer 15 is a conduit and the solids are transferred into the conveyer 15 via chute 25. Chute 25 is located behind screen 13 and is open for receiving debris collected by rakes 28 as they pass over the upper end of screen 13.

The solids separated from the screen 13 are conveyed to channel 16 of conveyor 15 for further processing. Channel 16 is angled downward in this example such that the solid waste travels down channel 16 due to natural forces of gravity toward chute 17. Alternatively channel 16 could be inclined upward and an auger employed to covey the solids. As is known and appreciated by those skilled in the art, conveyor 15 can have mechanical assemblies to assist the conveyance of the solid matter through conveyor 15. In the preferred embodiment, a wash water inlet 27 is positioned downstream of screen 13 for injecting water to mix with the solids or screenings from screen 13 within channel 16 of conveyor 15. In one embodiment, wash water entering water inlet 27 comprises water circulated from channel 23. In another embodiment, wash water injected through water inlet 27 into channel 16 of conveyor 15 comprises fresh water or other cleaning fluid for mixing with the solid waste. As will be readily appreciated by those skilled in the art, the solids entering channel 16 of conveyor 15 may have organic matter attached or adhered to the outer surface of the solids. It is advantageous to separate the organic matter from the exterior surfaces of the solids. In the preferred embodiment, the solids from screen 13 and the wash water injected through water inlet 27 are transferred through channel 16 of conveyor 15 toward agitator assembly 21. Preferably, the wash water flowing through inlet 27 is continuous.

Agitator assembly 21 preferably comprises an outer housing 31. Outer housing 31 has a tubular portion that is co-axial with an axis A extending through conveyor 15. Outer housing 31 defines an inner channel 32 that cooperates with channel 16 of conveyor 15. A pair of flanges 33 located on the upstream and downstream end portions of housing 31 register and connect to flanges 35 formed on conveyor 15 for connecting agitator assembly 21 to conveyor 15.

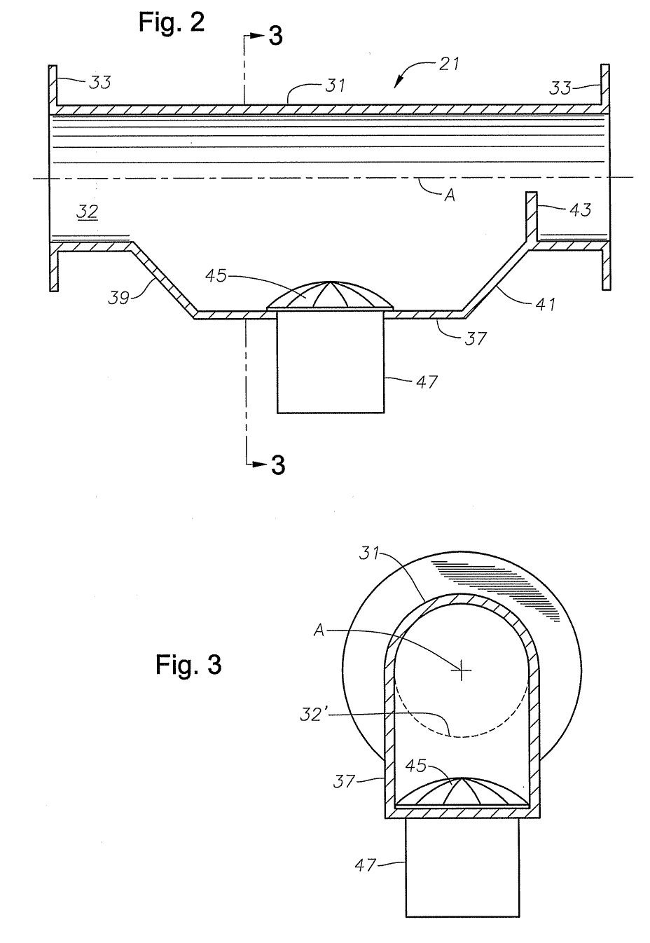

Referring to FIGS. 2 and 3, agitator assembly 21 preferably includes a recessed housing or sump 37 extending from a lower portion of housing 31. In the preferred embodiment, sump 37 includes a pair of inclined surfaces 39, 41 extending downward from the lower end portion 32′ of outer housing 31. Inclined surfaces 39, 41 define a depth of sump 37 below the lower portion 32′ of tubular housing 31. Optionally, a fixed-position weir 43 extends upward into channel 32 from an upper portion of inclined surface 41. Weir 43 is positioned downstream of recessed housing 37 so as to maintain a selected wash water depth in sump 37.

Agitator assembly 21 also comprises an agitator 45 positioned within sump 37. In the preferred embodiment, agitator 45 is positioned such that its impeller is lower than the lower most portion of tubular housing 31. Agitator 45 typically comprises a rotor or impeller assembly powered by a motor 47. As will be readily appreciated by those skilled in the art, the impeller assembly of agitator 45 can also be a high pressure injection means for injecting air or water into sump 37. Agitator 45 creates turbulent flow within sump 37 such that solids in the wash water within sump 37 are agitated to clean them. The turbulence and agitation within sump 37 helps to separate any organic matter from the outer surfaces of the solids within the solids and wash water mixture caught within sump 37.

After passing through channel 16 of conveyor 15 and being agitated within agitator assembly 21, the wash water and solids accumulate and flow over the upper edge of weir 43 and into a portion of conveyor 15 leading to chute 17. This flow over weir 43 of solids and wash water occurs continuously. The solids and the wash water are transferred through chute 17 into additional equipment 19 (FIG. 1) for farther processing. Additional equipment 19 could be a variety of devices. For example, equipment 19 could comprise a compactor or compacting the solids, which are subsequently dried. Equipment 19 could be paper processing equipment.

If processing equipment 19 comprises a compactor, it will compress the solids and squeeze the wash water from them. The wash water, which may have organic material separated from the solids, exits processing equipment 19 through a water outlet 29 for further processing.

As will be readily appreciated by those skilled in the art, treatment assembly 11 allows a continuous and systematic removal and treatment of solids from a liquid stream, rather than a batch process system, as was typically done by previous systems. Moreover, the positioning of agitator 45 is in a location such that agitator 45 is not in the direct flow of the wash water and solids traveling through channel 16 of conveyor 15 such that agitator 45 would impede flow therethrough.

While the invention has been shown in only one of its forms, it should be apparent to those skilled in the art that it is not so limited, but is susceptible to various changes without departing from the scope of the invention. In the drawings and specification, there have been disclosed illustrative embodiments of the invention and, although specific terms are employed, they are used in a generic and descriptive sense only and not for the purpose of limitation, the scope of the invention being set forth in the following claims.

We claim:

1. A method of removing solids from a liquid, comprising:
(a) separating the solids from the liquid with a screen filter; then
(b) depositing the solids into an agitator assembly;
(c) flowing wash water through the agitator assembly;
(d) operating the agitator assembly to clean the solids; and
(e) continuously removing the solids from the agitator assembly for further processing.

2. The method of claim 1, wherein steps (a)-(e) are performed simultaneously in a continuous operation.

3. The method of claim 1, wherein step (e) comprises
continuously flowing wash water out of the agitator assembly along with solids entrained entrained in the wash water.

4. The method of claim 1, further comprising:
providing an outlet of the agitator assembly to maintain a selected level of wash water within the agitator assembly; and step (e) comprises:
flowing wash water along with solids entrained therein through the outlet.

5. A method of removing solids from a liquid flowing through a channel, comprising:
(a) installing a screen filter in the channel and an agitator assembly outside of the channel;
(b) operating the screen filter to screen solids from the liquid in the channel and lifting the solids from the channel with the screen filter;
(b) depositing the solids lifted by the screen filter into the agitator assembly;
(c) continuously flowing wash water through the agitator assembly;
(d) operating the agitator assembly to clean the solids with the wash water; and
(e) continuously removing the solids from the agitator assembly for further processing.

6. The method according to claim 5 wherein step (e) comprises flowing the solids while entrained in the wash water out of the agitator assembly.

7. The method according to claim 5, wherein:
step (c) comprises continuously flowing the wash water out an outlet; and
step (e) comprises flowing the solids out the outlet along with the wash water.

8. The method according to claim 5, further comprising:
providing the agitator assembly with an outlet at a lower elevation than an inlet;
step (c) comprises flowing the wash water out the outlet; and
step (e) comprises flowing the solids out the outlet along with the wash water.

9. A treatment assembly for removing solids from a flowing liquid, comprising:
a screen filter having a portion immersed in the flowing liquid, the screen filter trapping solids in the flowing liquid and lifting the solids out of the flowing liquid; and
an agitator assembly mounted in cooperation with the screen filter for receiving the solids lifted by the screen filter;
a wash water inlet in the agitator assembly for flowing wash water into the agitator assembly, the agitator assembly having an agitator that creates turbulence in the wash water to clean the solids; and
means for continuously removing the solids from the agitator assembly.

10. The assembly of claim 9, wherein the means for continuously removing the solids composes:
an outlet in the agitator assembly that is fixed in an open position for continuously discharging the solids along with the wash water.

11. The assembly of claim 9, wherein the means for continuously removing the solids comprises:
an outlet in the agitator assembly that is fixed in an open position;
a weir at the flow outlet of the housing for maintaining a liquid level within the housing such that the agitator is completely submerged; and
the height of the weir is selected so that the wash water along with the solids entrained therein flows continuously over an upper end of the weir.

12. The assembly of claim 9, wherein the agitator comprises an impeller that is rotated.

13. The assembly of claim 9, wherein the agitator assembly comprises:
a housing having a flow inlet for receiving the wash water and a flow outlet at an elevation below the flow inlet for discharging the wash water;
a sump located within the housing, the agitator being contained within the sump below the flow inlet and flow outlet; and
the flow outlet is located at a lower elevation than the flow inlet.

14. The assembly of claim 13, wherein the housing further comprises a weir located at the flow outlet of the housing.
